(19) United States
(12) Patent Application Publication
(10) Pub. No.: US 2004/0020866 A1
(43) Pub. Date: Feb. 5, 2004

(54) Liquid dispersion filtration and delivery apparatus and method

(75) Inventors: John M. Hammond, Livonia, NY (US); Paul C. Lincoin, Center Valley, PA (US); J. Michael Sanchez, Fairport, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/600,213

(22) Filed: Jun. 20, 2003

Related U.S. Application Data
(60) Provisional application No. 60/398,025, filed on Jul. 22, 2002.

(51) Int. Cl. C02F 1/00

(52) U.S. Cl. 210/767; 210/143

(57) ABSTRACT

A dispersion fluid filtration and delivery apparatus and method are provided for filtering a dispersion fluid from a storage vessel and delivering a filtrate thereof to a filtrate using operation. The dispersion fluid filtration and delivery apparatus for the method includes (a) a filter device having an inlet port, a first outlet port for connecting to the storage vessel, and a second outlet port for connecting to the filtrate using operation; (b) an inlet pump connected between the inlet port and the storage vessel for pumping a first quantity Qᵢₙ of dispersion fluid into the filter device; and (c) an outlet pump connected between the first outlet port and the storage vessel for pumping a second quantity Qₒᵤₜ of dispersion fluid from the filter device back into the storage vessel. The outlet pump and the inlet pump are sized and controlled so that Qₒᵤₜ is less than Qᵢₙ, and so that the resulting filtrate flow Qᵣ from the filter device through the second outlet port to the filtrate using operation is equal to Qᵢₙ−Qₒᵤₜ.

This application is based on a provisional application No. 60/398,025 filed Jul. 22, 2002.

### FIELD OF THE INVENTION

This invention relates to liquid dispersion filtration and delivery processes in the manufacturing or fabrication of products in which effective filtration is required in order to ensure the quality of end products, for example, the manufacturing or fabrication and coating of thin films such as photoconductors, photographic film, and magnetic films. In particular, the invention relates to a high precision, high purity micro-filtered coating dispersion filtration and delivery apparatus including a crossflow filtration device in close proximity to its coating operation.

### BACKGROUND OF THE INVENTION

Photoconductive members or photoreceptors, that are for example organic, and which are used in xerographic machines, are well known. In the manufacture or fabrication of organic photoreceptors of the like, an organic solvent, a binder resin, and a pigment can be combined and milled for use in a charge generation layer thereof. The pigment and binder resin are chosen to optimize their photoelectric properties, but it is not always possible to optimize the dispersion quality of the resulting coating solution. Charge generating solutions that become unstable over time are a common problem in the fabrication of certain organic photoreceptors. Unstable dispersions and particulate impurities result in coating defects in the charge generating layer that lower coating yield during the fabrication process.

Current photoreceptor coating dispersions containing pigments such as benzimidazole perylene and hydroxygallium phthalocyanine flocculate extensively when quiescent or when handled at low shear flow conditions. Conventional filters in which all of the coating fluid entering the filter housing passes through the filter element typically operate at low shear near the surface of the filter medium. Thus, when a highly flocculating dispersion is delivered into a conventional filter device by a conventional delivery system, flocs of pigment ordinarily tend to form near the surface of the filter medium. The flow field moves the flocs onto the surface and into the bulk of the filter medium, ultimately resulting in plugging of the filter. In photoreceptor manufacturing or similar film or web coating operations, a plugged filter may cause as much as one hour of downtime, including restart and stabilization of the coating process (for example, for the purging of air bubbles from the filter device) This is obviously a costly interruption of the manufacturing process.

In one coating process embodiment, an initial countermeasure to the filter problem was simply to use a filter element with a 40 micron pore size. Such a pore size was large enough that the pigment flocs, which form near the filter medium, did not plug the filter. Attempts to filter the dispersion using filter elements rated to retain particles small than 40 μm resulted in plugging of the filters with pigment flocs.

However, in embodiments of organic photoreceptor manufacturing, and other thin film device manufacturing it is undesirable to use a filter that will allow the passage of particles in the 1 micron to 40 micron size range. Such particles and/or flocs may disrupt flow out of the extrusion die or other coating applicator, causing streaks. Also, the presence of particles this large in the wet coated generator layer are known to result in defects in the dried generator layer. Both particles and streaks will show as defects in the final printed output to the end customer; therefore, any photoreceptor having such defects will not be acceptable.

The suggested use of a crossflow filter is an improvement over prior art filters. However, conventional coating fluid delivery systems in which such a filter is installed are ordinarily not optimum. They are often complex and do not locate the filter in close proximity to the coating die or other coating applicator. Therefore, such a conventional delivery system does not to minimize the incidence of particulate defects and pigment flocs which may be present in the coating fluid that is delivered into the die, and subsequently onto the coated film or photoreceptor. As such, the problem of filtering the coating dispersion at a process location immediately before and in close proximity to the coating application has not been addressed.

### SUMMARY OF THE DISCLOSURE

In accordance with the present invention, there is provided a dispersion fluid filtration and delivery apparatus and method for filtering a dispersion fluid from a storage vessel and delivering a filtrate thereof to a filtrate using operation. The dispersion fluid filtration and delivery apparatus for the method includes (a) a filter device having an inlet port, a first outlet port for connecting to the storage vessel, and a second outlet port for connecting to the filtrate using operation; (b) an inlet pump connected between the inlet port and the storage vessel for pumping a first quantity Qᵢₙ of dispersion fluid into the filter device; and (c) an outlet pump connected between the first outlet port and the storage vessel for pumping a second quantity Qₒᵤₜ of dispersion fluid from the filter device back into the storage vessel. The outlet pump and the inlet pump are sized and controlled so that Qₒᵤₜ is less than Qᵢₙ, and so that the resulting filtrate flow Qᵣ from the filter device through the second outlet port to the filtrate using operation is equal to Qᵢₙ−Qₒᵤₜ.

### BRIEF DESCRIPTION OF THE DRAWINGS

In the detailed description of the invention below, reference is made to the drawings, in which:

FIG. 1 is a schematic diagram of a conventional fluid filtration and delivery system including a crossflow filter device;

FIG. 2 is a schematic diagram of the coating dispersion filtration and delivery assembly of the present invention;

FIG. 3 is a schematic, cross-sectional elevational view of a typical crossflow device for use in the coating dispersion filtration and delivery assembly of the present invention;

FIGS. 4 and 5 are each a schematic diagram of the coating dispersion filtration and delivery assembly of the present invention including a is diverter valve in the “on” and “off” modes respectively; and

FIG. 6 is a plot of actual measured filtrate flow over a range of 0-90 pump drive RPM in the coating dispersion filtration and delivery assembly of the present invention.

### DETAILED DESCRIPTION OF THE PRESENT INVENTION

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

The present invention is useful in performing liquid dispersion filtration and delivery processes to filtrate using operations. Such filtrate using operations may comprise, for example, coating operations used in the manufacturing or fabrication of products in which effective filtration is required in order to ensure the quality of end products, including the manufacture of organic photoreceptors by die coating, dip coating, spray coating, and the like. As used herein, a dispersion is meant to be any fluid comprising a liquid phase in which substantially solid particles are suspended, and remain suspended, at least temporarily.

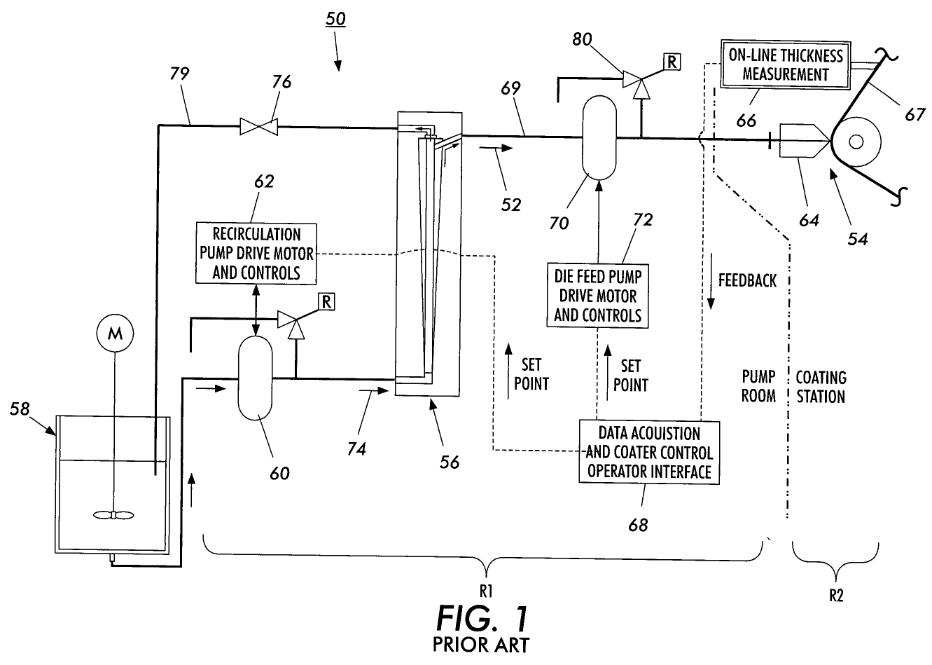

Referring now to FIG. 1, there is illustrated schematically, a conventional, prior art filtration and delivery assembly 50 for delivering a micro-filtered charge generator coating dispersion 52 to a high precision, high purity liquid processing operation 54, such as an organic belt photoreceptor die coating operation. As illustrated, the conventional filtration and delivery assembly 50 is located ordinarily in two different rooms, the pump room R1, and the operations room or area R2 where the high precision, high purity liquid processing operation 54 is located. As further illustrated, the filtration and delivery assembly 50 includes a filter device 56, a coating fluid vessel 58, a recirculation pump 60 with drive motor and controls 62, and a separate coating die 64 feed pump 70 with its own drive motor and controls 72 that conventionally are located in the pump room R1, a significant or long distance away from the coating operation 54. The coating operation 54 located such a long distance away utilizes a coating die 64 and a thickness measurement device 66 for coating a film 67 for example. A data acquisition and coater control interface 68, and various pressure gauges and sections of conduit or tubing 69 are also utilized.

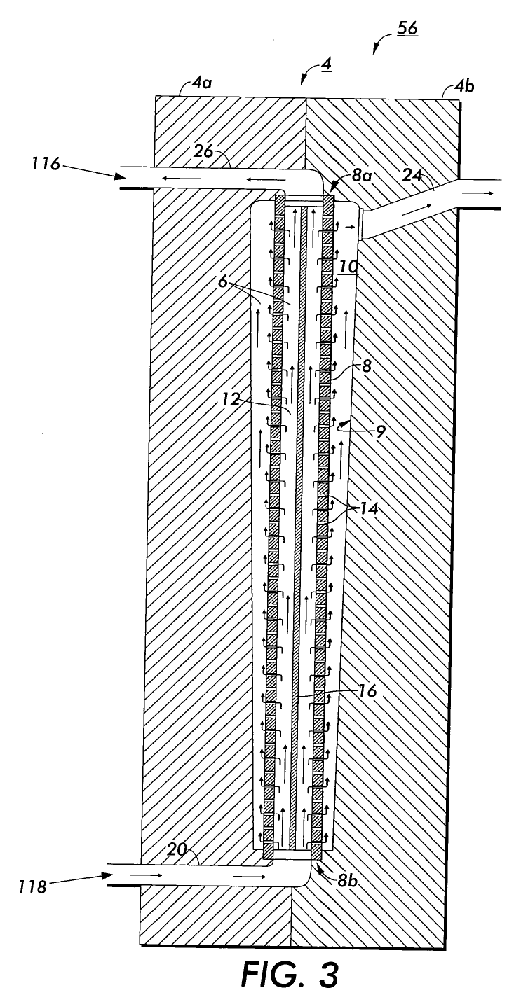

In operation, the recirculation pump 60 in the pump room R1 delivers a substantial volume 74 of coating liquid through the cross-flow filter device 56, while a throttling valve 76 provides a controlled restriction in a return conduit of tubing 79 that returns the liquid to the coating vessel 58. This restriction provides an increased fluid pressure in the recirculating fluid within the filter device 56 which forces a small portion of the fluid as the dispersion 52 through the filter medium 8 (see FIG. 3), but undesirably backs up and stalls filtered particulates within the filter 56, thereby shortening the life of the filter. The filtered fluid 52 is then metered and fed to the coating die 64 by the die feed pump 70.

The operation of this conventional filtration and delivery assembly 50 as described above is not optimal. Conventionally, the throttling valve 76 is typically hand operated and hand set by an operator in order for equalizing the pressures on each side of the die feed pump 70. Although an automated metering valve could be used, there are other deficiencies. The recirculation pump 60 and die feed pump 70 are independently controlled (see controls 62 and 72), and as filtration conditions change within the filter 56, (for example, as the filter pores begin to accumulate some solid material), separate adjustments usually are required for each pump (60, 70) in order to maintain the desired coating thickness at 66. Such adjustments conventionally are being accomplished by trial and error, and based on data from the on-line thickness measurement device 66.

Most importantly, as pointed out above, the configuration of equipment in the conventional fluid filtration and delivery assembly 50 is such that the filter 56 is located a considerable distance in Rl from the filtrate using operation, for example the coating die 64 in R2. As a consequence, there is a complex sequence of tubing 69, pipe fittings, a pump 70, and valves including for example relief valve 80 between the filter 56 and the coating die 64. This configuration of equipment has been found to include numerous low-velocity and zero velocity (dead space) volumes of liquid therein where particulate contaminates can collect, and be subsequently released, thereby causing disturbances in filtrate flow, as well as defects in the coated film 67.

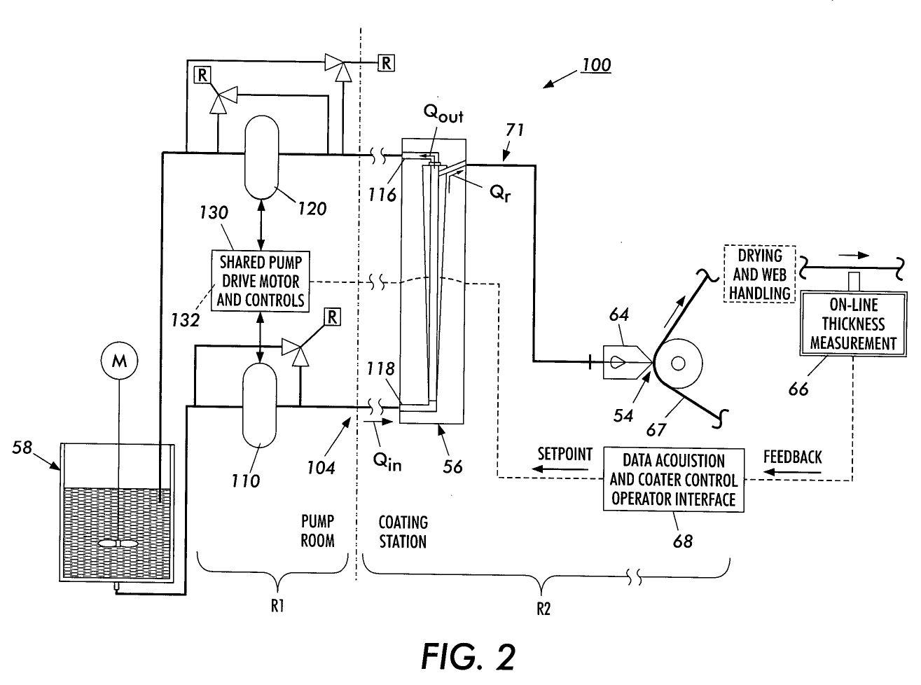

Referring now to FIG. 2, there is illustrated the coating dispersion filtration and delivery apparatus 100 of the present invention including a filtration assembly 104 consisting of a crossflow filtration or filter device 56 located in the operations area R2 in close proximity to the filtrate using operation or coating head or die 64, and a filter inlet pump 110 and a filter outlet pump 120 located within R1 and preferably having a single shared or common drive motor and controls 130. The filtration and delivery assembly 100 also includes the coating fluid vessel 58, a coating die 64, a thickness measurement device 66, a data acquisition and coater control interface 68, and various pressure gauges and sections of tubing 71.

To operate the filtration assembly 104 (comprising inlet pump 110, filter device 56 and outlet pump 120), the filter inlet pump 110 which is located in the pump room R1 delivers a precisely metered flow Qᵢₙ of fluid into the filter recirculation inlet port 118; while the filter outlet pump 120 allows a precisely metered flowrate Qₒᵤₜ of fluid out of the filter recirculation outlet port 116. The capacities C1 and C2, as well as the operating speeds, of the inlet and outlet pumps 110, 120 are chosen and set so that the flowrate of fluid Qᵢₙ into the filter inlet port 118 is greater than the flowrate of fluid Qₒᵤₜ out of the filter outlet port 116. As such, it is preferable that the filter inlet and outlet pumps 110, 120 are high precision positive displacement metering pumps, such as pumps made by the Zenith Division of the Parker Hannefin Corporation of Sanford, N.C.

It is also preferable that the displacement per revolution of the inlet pump 110 be between 10 percent and 50 percent greater than that of the outlet pump 120; and that the two pumps 110, 120 be driven by the same pump drive motor 132 (typically an electric motor), and have a common control system 130. In this manner, when the two pumps 110, 120 are engaged with the drive motor 132, and are turning at the same RPM due to common control 130, the resulting output Qᵣ of filtrate through the filter medium and onto the coating die 64 is simply

Qᵣ=RPM×(Cᵢₙ−Cₒᵤₜ),

where Qᵣ is the rate of filtrate flow through the filter medium; RPM is the pump speed in revolutions per minute; Cᵢₙ is the capacity of the inlet pump 110 in cubic centimeters of liquid per pump shaft revolution; and Cₒᵤₜ is the capacity of the outlet pump 120 in cubic centimeters of liquid per pump shaft revolution (assuming that the pumps operate at 100% efficiency).

It will be apparent that the output of filtrate Qᵣ through the filter is therefore able to be determined by control of a single and commonly controlled process variable, namely pump drive RPM. It will be further apparent that the coating fluid vessel 58, filter inlet pump 110, filter outlet pump 120, and shared drive motor and controls 130, 132 can be all located in a single location such as the pump room R1. The filter 56 can thus be remotely located in R2 and advantageously in very close proximity to the coating die 64 or other dispensing device 64 at the coating station 54. This arrangement minimizes the possibility of particulate contaminants being entrained in the filtrate stream between the filter 56 and the coating die 64, thereby improving product yields. The filtration and delivery assembly 100 as such will more effectively provide more highly purified and non-flocculated coating dispersion Qᵣ to the coating die 64 than conventional fluid filtration and delivery assemblies, thereby resulting in improved yields in e.g., organic belt photoreceptor manufacturing.

Referring now to FIG. 3, the filter device 56 can for example be a crossflow filter. As illustrated, the filter 56 comprises a housing 4 defining a channel 6; a hollow, porous filter medium 8 positioned in the channel of the housing, wherein the channel 6 is partitioned by the filter medium 8 into an exterior passageway 10 that is exterior to the filter medium and an interior passageway 12 that is interior to the filter medium. The exterior passageway 10 and the interior passageway 12 are in communication via the pores 14 of the filter medium. The liquid to be filtered flows into inlet port 118 to the interior passageway 12 via an inlet conduit 20. The exterior passageway 10 is in communication with a liquid dispensing outlet conduit 24. The interior passageway 12 is in communication with a recirculation outlet conduit 26 for recirculating the liquid from the outlet port 116 through equipment (not shown in FIG. 2) back to the inlet port 118.

The housing 4 comprises a left piece 4a and a right piece 4b suitably joined together by clamps, bolts, or other suitable fastening means (not shown). The porous filter medium 8 is preferably tubular, and made of sintered stainless steel, although any porous medium which (a) has sufficiently small pores to prevent passage of particulate impurities and (b) is resistant to chemical or physical degradation by the liquid being filtered may be suitable. For example, the porous filter medium could be made of ceramic, or of a suitably resistant polymer such as TEFLON®. In one embodiment of the filter medium, a sintered stainless steel cylindrical tube 30 cm long×0.96 cm (inner diameter)×1.19 cm (outer diameter) with an absolute retention rating of 5 micrometers can be used. This tube is a Grade S050 of the S-Series PSS Medium of the Pall Corporation of Cortland N.Y. Other tubes such as the SIKA-R tubes with retention ratings from 0.5 to 10 micrometers available from the GKN Sinter Metals Corporation of Richton Park Ill. would also be suitable. The wall of the filter medium comprises the pores which limit the particles which may pass through the filter medium to those particles which are less than a desired size. The filter medium 8 can be chosen such that particles which may pass through the medium are less than 5 microns in maximum dimension. Filter medium 8 for example is held in the channel 6 formed between the two pieces (4a, 4b) of the housing and at ends 8a and 8b of filter medium 8.

Referring still to FIG. 3, the exterior passageway 10 is preferably annular in cross section, with the inner surface of exterior passageway 10 being defined by the outer surface of the filter medium 8 (also referred herein as filter tube or tube), and the outer surface of exterior passageway 10 being defined by the machined surface 9 of channel 6 in housing 4.

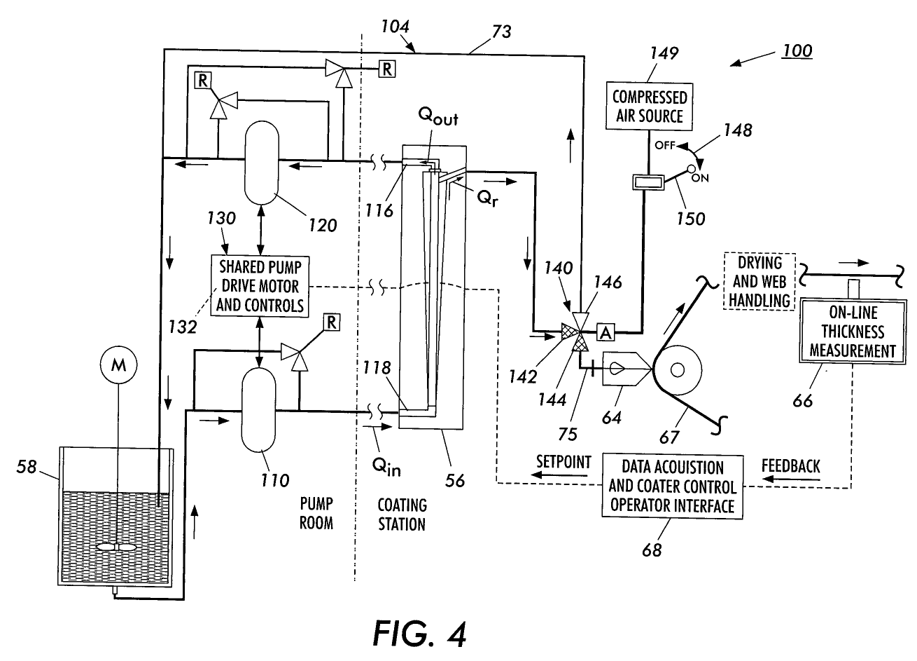

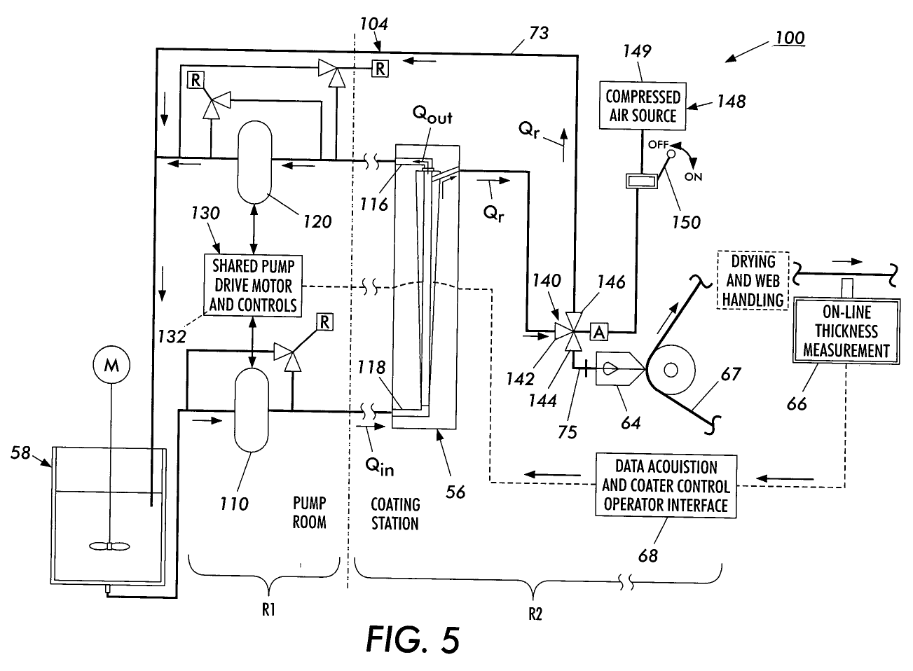

Referring now to FIGS. 4-5, the fluid filtration and delivery assembly 100 further includes a diverter valve 140 that can be turned on and off via means 148, and that is located between the crossflow filter 56 and the coating die 64, and is connected by a bypass return conduit 73 back to the vessel 58, and by a continuation feed conduit 75 to the to the coating die 64. The diverter valve 140 includes an inlet port 142, a first outlet port 144 connected to the conduit 75, and a second outlet port 146 connected to the conduit 73. The diverter valve 140 also includes suitable means 148 for switching the valve mechanism to direct flow either from the inlet port 142 through the first outlet port 144; or from the inlet port through the second outlet port 146. The diverter valve 140 may be one of several common valves known in the art such as a ball valve, a spool valve, a diaphragm valve, and the like.

It is preferable to use a diverter valve 140, because in the absence of such a valve (as shown in FIGS. 4 and 5), the only method to stop fluid flow to the coating die 64 is to stop the pump drive motor 132, thereby stopping the flow of fluid through the filter 56. This is an undesirable method, particularly when filtering dispersions that flocculate at low or zero shear rates. Such stoppage obviously will dramatically increase the rate of flocculation.

The system of FIG. 4 is referred to as being in the “on” or “on-coat” mode in which the resultant flow Qᵣ flows to the filtrate using operation or die head 64 for coating operations. Referring to FIG. 5, the diverter valve 140 is actuated such that filtrate flow enters the inlet port 142 of the valve, and exits a second outlet port 146 connected to the fluid storage vessel. The system of FIG. 5 is referred to as being in the “off” or “off-coat” mode in which the resultant flow Qᵣ flows back to the storage vessel 58. Thus, constant fluid flow can be maintained through the filter 56 when an interruption of the coating or other dispensing process becomes necessary. The system has the added advantage that when the diverter valve 140 is equipped with a suitable actuator 149, 150 with a fast response time, the system can quickly switch between the “on-coat” and “off-coat” modes. Examples of suitable actuators include, but are not limited to, electric solenoid actuators, and pneumatic actuators (as shown in FIGS. 4 and 5).

The following example is illustrative of one embodiment of the present invention. A fluid filtration and delivery assembly 100 was assembled, comprising an inlet pump 110 with a theoretical capacity of 27.8 cm³/rev.; and an outlet pump 120 with a theoretical capacity of 20.2 cm³/rev., thereby providing a theoretical capacity of 7.2 cm³/rev. of filtrate flow Qᵣ. Trials were run with sintered stainless steel filter tubes made by the Mott Corporation rated at 10 microns and 20 microns absolute retention, respectively. The apparatus 100 of FIGS. 4 and 5 was connected to a bench mounted coating die having a slot width of approximately 16 inches and a slot height of approximately 0.008 inches, which was formerly used in organic belt photoreceptor manufacturing. Accordingly, this die was representative in substantially simulating the resistance of a variety of coating dies 64 or other dispensing devices or filtrate using devices.

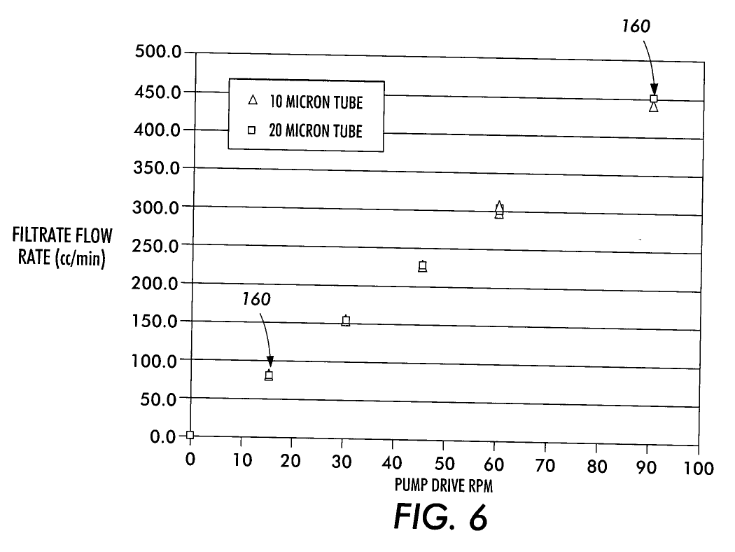

Data for each trial is provided in FIG. 6. Referring to FIG. 6, it is apparent that the theoretical filtrate output of 7.2 cm³/rev. was not achieved. This is likely due to some fluid slippage within the pumps. In other words, the actual capacity Cᵢₙ of the inlet pump was somewhat less than 27.8 cm³/rev., and the actual capacity Cₒᵤₜ of the outlet pump was somewhat greater than 20.2 cm³/rev., such that a very linear output of filtrate flow shown as 160 over the range of 0-90 pump drive RPM was achieved, with an output (slope of the lines) of approximately 5.0 cm³/rev. It is thereby demonstrated that the fluid filtration and delivery assembly 100 of the present invention is an effective system for metering filtrate through a cross-flow filter using a single control variable, pump drive RPM.

As can be seen, there has been provided a dispersion fluid filtration and delivery apparatus and method for filtering a dispersion fluid from a storage vessel and delivering a filtrate thereof to a filtrate using operation. The dispersion fluid filtration and delivery apparatus for the method includes (a) a filter device having an inlet port, a first outlet port for connecting to the storage vessel, and a second outlet port for connecting to the filtrate using operation; (b) an inlet pump connected between the inlet port and the storage vessel for pumping a first quantity Qᵢₙ of dispersion fluid into the filter device; and (c) an outlet pump connected between the first outlet port and the storage vessel for pumping a second quantity Qₒᵤₜ of dispersion fluid from the filter device back into the storage vessel. The outlet pump and the inlet pump are sized and controlled so that Qₒᵤₜ is less than Qᵢₙ and so that the resulting filtrate flow Qᵣ from the filter device through the second outlet port to the filtrate using operation is equal to Qᵢₙ−Qₒᵤₜ.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims:

What is claimed is:

1. A dispersion fluid filtration and delivery system for filtering a dispersion fluid from a storage vessel and delivering a filtrate thereof to a filtrate using operation, the dispersion fluid filtration and delivery system comprising:
(a) a filter device having an inlet port, a first outlet port for connecting to the storage vessel, and a second outlet port for connecting to the filtrate using operation;
(b) an inlet pump connected between said inlet port and the storage vessel for pumping a first quantity Qᵢₙ of dispersion fluid from the storage vessel through said inlet port into said filter device; and
(c) an outlet pump connected between said first outlet port and the storage vessel for positively pumping a second quantity Qₒᵤₜ of dispersion fluid from said filter device back into said storage vessel, said outlet pump and said inlet pump being sized and controlled so that Qₒᵤₜ is less than Qᵢₙ, and so that resulting filtrate flow Qᵣ from said filter device through said second outlet port to the filtrate using operation is equal to Qᵢₙ−Qₒᵤₜ.

2. The dispersion fluid filtration and delivery system of claim 1, including a single common drive motor for driving said inlet pump and said outlet pump.

3. The dispersion fluid filtration and delivery system of claim 1, wherein said inlet pump and said outlet pump have common shared controls for ensuring simultaneous operation.

4. The dispersion fluid filtration and delivery system of claim 1, wherein said filter device is a crossflow filter.

5. The dispersion fluid filtration and delivery system of claim 1, further comprising a diverter valve having an inlet connected to second outlet port of said filter device, a first outlet connected to the filtrate using operation, and a second outlet connected to the storage vessel for enabling continuous operation of the filtration assembly during an interruption of the filtrate using operation.

6. The dispersion fluid filtration and delivery system of claim 1, wherein said filter device is located in close proximity to the filtrate using operation in an operating area and remotely from said inlet pump and said outlet pump so as to minimize a risk of flocculation of the filtrate between said filter device and the filtrate using operation.

7. The dispersion fluid filtration and delivery system of claim 3, wherein said shared common controls are connected to a filtrate using data acquisition and control interface.

8. The dispersion fluid filtration and delivery system of claim 3, wherein said shared common controls are set such that Qᵣ=RPM×(Cᵢₙ-Cₒᵤₜ), where Qᵣ is the rate of filtrate flow through the filter medium; RPM is the pump speed in revolutions per minute; Cᵢₙ is the capacity of the inlet pump 110 in cubic centimeters of liquid per pump shaft revolution; and Cₒᵤₜ is the capacity of the outlet pump 120 in cubic centimeters of liquid per pump shaft revolution.

9. The dispersion fluid filtration and delivery system of claim 4, wherein said crossflow filter comprises a housing, a porous filter medium contained within said housing and including a first surface and a second surface, a first passageway through said housing contiguous with at least a portion of said first surface of said porous filter medium, and a second passageway through said housing contiguous with at least a portion of said second surface of said porous filter medium.

10. The dispersion fluid filtration and delivery system of claim 5, including switching means for switching said diverter valve between flow to the filtrate using operation and flow back to the storage vessel.

11. A method of filtering and delivering a fluid dispersion from a storage vessel to a filtrate using operation comprising:
(a) first pumping fluid dispersion at an input rate Qᵢₙ from the storage vessel into an inlet port of a filter device having a filter medium, a first outlet port connected back to the storage vessel, and a second outlet port connected to the filtrate using operation;
(b) next pumping fluid dispersion at a first output rate Qₒᵤₜ from the filter device through said first outlet port for return to said storage vessel, wherein said first output rate Qₒᵤₜ is less than said input rate Qᵢₙ;
(c) directing filtrate fluid from the filter device through said second outlet port at a second output rate Qᵣ through said filter medium, wherein said second output rate Qᵣ is equal to Qₒᵤₜ−Qᵢₙ; and
(d) next directing the filtrate fluid from said second outlet port to said filtrate using operation at the second output rate of Qₒᵤₜ−Qᵢₙ.

12. The method of claim 11, wherein said pumping and said next pumping steps include using a single common drive motor for driving said inlet pump and said outlet pump.

13. The method of claim 11, wherein said pumping and said next pumping steps include using common shared controls for controlling said inlet pump and said outlet pump.

14. The method of claim 11, wherein said directing step includes using a crossflow filter device.

15. The method of claim 11, further comprising a diverter valve having an inlet connected to second outlet port of said filter device, a first outlet connected to the filtrate using operation, and a second outlet connected to the storage vessel for enabling continuous operation of the filtration assembly during an interruption of the filtrate using operation.

16. The method of claim 11, wherein said next directing step includes locating the filter device in close proximity to the filtrate using operation in an operating area and remotely from said inlet pump and said outlet pump so as to minimize a risk of flocculation of the filtrate between said filter device and the filtrate using operation.

17. The method of claim 13, wherein said shared common controls are connected to a filtrate using data acquisition and control interface.

18. The method of claim 13, wherein said shared common controls are set such that Qᵣ=RPM×(Cᵢₙ-Cₒᵤₜ), where Qᵣ is the rate of filtrate flow through the filter medium; RPM is the pump speed in revolutions per minute; Cᵢₙ is the capacity of the inlet pump 110 in cubic centimeters of liquid per pump shaft revolution; and Cₒᵤₜ is the capacity of the outlet pump 120 in cubic centimeters of liquid per pump shaft revolution.

19. The method of claim 14, wherein said crossflow filter comprises a housing, a porous filter medium contained within said housing and including a first surface and a second surface, a first passageway through said housing contiguous with at least a portion of said first surface of said porous filter medium, and a second passageway through said housing contiguous with at least a portion of said second surface of said porous filter medium.

20. The method of claim 15, including switching means for switching said diverter valve between flow to the filtrate using operation and flow back to the storage vessel.
